(19) United States
(12) Patent Application Publication
(10) Pub. No.: US 2005/0119904 A1
(43) Pub. Date: Jun. 2, 2005

(54) Cargo handling security handling system and method

(76) Inventors: A. R. Tissington, Makati City (PH); Dennis E. Concepcion, Metro Manila (PH)

Correspondence Address: Unisys Corporation;Attn: Michael B. Atlass, MS/E8-114, Unisys Way, Blue Bell, PA, 19424-0001, US

(21) Appl. No.: 10/725,666

(22) Filed: Dec. 2, 2003

(51) Int. Cl. G06F 17/60

(52) U.S. Cl. 705/1

(57) ABSTRACT

This invention teaches that a systematic approach to security can yield high volume cargo transshipment with some degree of security. It relies upon the ability of a transshipment point to do gamma ray inspection of cargo containers, and provides a framework in which such inspections can be limited to improve commercial conditions and throughput of the port. Cargo documentation is first input into the system and profiles generated for each cargo container. Additional sources as well as “thesaurus” data checking is done in a security module to make adjustment to the risk profile developed based on the documentation. The nature and severity of the inspections performed on the cargo are adjusted in accord with the profile developed as determined by a set of “business rules” within the security module.

### BACKGROUND

This invention relates to the processes and systems of determining what cargo is safe to pass through trans shipment points including shipping port systems, and has particular application to seaports because of the high volume of container cargo shipments handled by such facilities.

It has become of critical importance to the safety of the commercial world and its citizens that we satisfy the need to effectively and accurately identify possible security risks in both incoming and outgoing cargo containers that are processed in ports. The destruction of the World Trade Towers through the hijacking of commercial airliners loaded with fuel on Sep. 11, 2001 highlighted the vulnerability of the world to terrorist attacks. It is realized that approximately 90% of the world's goods move through seaports, however, the maritime industry has inherent vulnerabilities to terrorist attacks and other terrorist activities, which this invention is designed to address.

Many are looking to solve this problem. Some hope to use satellites, biometrics technology and radio-frequency identification tags, or RFID, to track containers, also use computer systems designed to gather and transmit data about the goods more efficiently than traditional paperwork. The entire chain of custody has to be reviewed, from the factory to the store, and where potential vulnerabilities lie in the chain.

One easy example is the vulnerabilities of coffee beans in their route to the U.S. Port workers in Brazil load containers filled with coffee beans onto ships, which bring them to the port of Bayonne, N.J. Port workers there load it onto trucks operated by a separate company. Finally, the beans end up at a Sara Lee roasting facility in Moonachie, N.J.

The coffee itself isn't the risk. It's that the containers themselves that can be tampered with, and terrorists could open the containers at various points en route to store weapons or other materials in the containers.

One potential help is to have sensors attached to cargo containers transmit real-time data via satellite to a central location, including whether the containers have been opened.

It is currently believed that only 5% of cargo containers arriving in the U.S. are actually scanned for weapons and other contraband.

As Robert Bonner, U.S. Customs Commissioner, said in Congressional testimony last month, “Quite frankly, it would be counterproductive and damaging to the U.S. economy to inspect 100 percent of the seven million sea containers or the 11 million trucks that arrive in the United States every year. We must use some risk-management techniques to identify and screen the relatively few high-risk shipments out of the millions of virtually no-risk shipments.”

Additionally, processing of shipments can also be merely delayed, and can become opportunities for fraud and corruption. The sheer volumes of containers that pass through seaports each day make it difficult to identify possible security threats that may be hidden among cargoes.

Processing of information alone is a big challenge due to several factors, notable of which are the following:
Cargo documents (especially manifest data), are traditionally lacking in information and this hampers port officials in correctly establishing the contents of containers. Among the most common problems in these documents is the lack of relevant information, the use of vague or incomplete descriptions, different terms/names used for the same goods and the omission, whether deliberately or not, of vital information from these documents.
Contrabands, drugs and illegal substances together with components that can be used to manufacture or assemble weapons of mass destruction, are shipped separately to avoid suspicion and detection. (An example is the smuggling of component substances that can be used to manufacture bombs. For example, Nitrate has traditionally been imported for use as fertilizer in farms. However, this chemical is also used for the manufacture of bombs. Unless certain business rules are defined to determine the acceptable amount of these substances that can be considered for legal use, this multiplicity in end-use will always be subject to abuse.)
International trade presents an inherent problem in language differences. While there may be accepted standards, differences in terminologies cannot be completely avoided. This presents a problem to receiving ports that may not have the resources to correctly evaluate documents with foreign terminologies. In view of the situation, port officials may not have any other recourse but to do physical inspection of the containers, an exercise that would not have been required for an otherwise valid shipment.

Additionally, there are commercial and political reasons that constrain the kinds of solutions to this problem that can be actually used. Among these reasons are:
Public dissatisfaction. Following the events of 9/11, the US government came under the most scathing public outrage over its seemingly inadequate security preparedness. The increased cost of transporting passengers and goods across security conscious maritime boundaries boils down to higher consumer prices. The tedious processes adopted early on by countries caught flatfooted by these terrorist attacks slowed down processing of passengers and cargoes to an unacceptable timetable.
Budget constraints. Third world economies have notoriously small budgets for revenue-generating agencies like inspection services, border posts etc. The mega-economies, by bounding themselves to create a security corridor on the trade routes, are effectively shutting out the developing economies that can ill-afford to acquire and implement sophisticated and expensive solutions that can comply with their emerging security standards. There is no hard and fast solution model that will apply to all economies. Any solution should therefore scale to the needs and capacities of the country (or even the specific port) that will implement them.
Economic Implications. The implications of not complying with the emerging standards for maritime security can be staggering. For developing countries whose main exports are agricultural, the prospect of agricultural produce rotting away while the cargo ships wait for clearance to dock at ports can be economically debilitating.

There is then clearly a need to have the capability to identify potentially risky shipments early on in the supply chain, or at the very least at the most critical stages. Key components required will be the availability of relevant information that can be used to evaluate data being supplied regarding incoming and outgoing cargoes, systems and processes to effectively use the information in real time to process, discover and interdict dangerous or illegal cargoes.

### BRIEF DESCRIPTION OF THE DRAWINGS

FIG. 1 is a flow diagram of the basic processes employed in preferred embodiments of the invention.

FIG. 2 is a block diagram of components of the inventive system.

FIG. 3 is a detailed block diagram indicating how components and processes affect each other in preferred embodiments of the invention.

### SUMMARY OF THE INVENTION

This invention teaches that a systematic approach to security can yield high volume cargo transshipment with some degree of security. It relies upon the ability of a transshipment point to do gamma ray inspection of cargo containers, and provides a framework in which such inspections can be limited to improve commercial conditions and throughput of the port. Cargo documentation is first input into the system and profiles generated for each cargo container. Additional sources as well as “thesaurus” data checking is done in a security module to make adjustment to the risk profile developed based on the documentation. The nature and severity of the inspections performed on the cargo are adjusted in accord with the profile developed as determined by a set of “business rules” within the security module.

Additional features are described which enhance use of the system and detail the inventive methods applicable thereto.

### DETAILED DESCRIPTION OF THE PREFERRED EMBODIMENTS

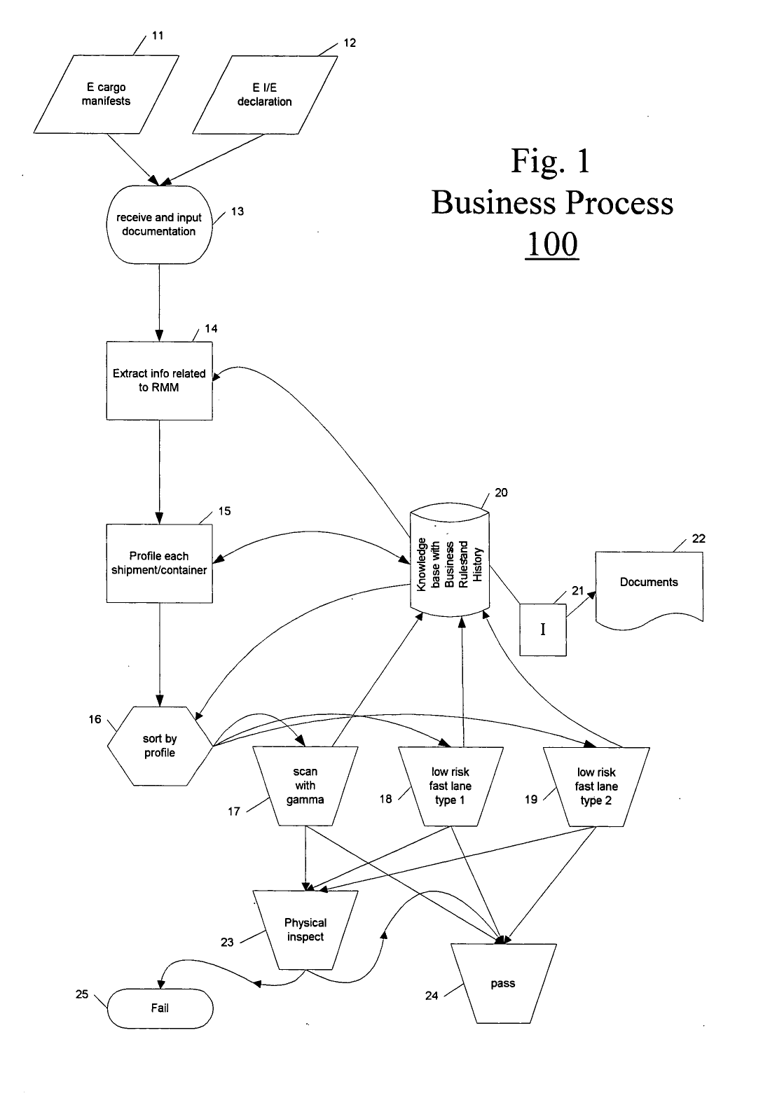

FIG. 1 illustrates the typical process flow of our preferred embodiment. Refer now to FIG. 1 in which the business process 100 is outlined in flowchart form. The process begins with cargo manifests and import/export declarations 11 and 12. If proper data interfaces are in place between the shipping port handling security matters and the businesses generating the manifests and declarations, electronic documents in the form of XML documents preferably are provided to the security system. The first step 13 in the process is to receive and input the documentation data. An information management system I (21) monitors and controls a knowledge base (20) which may be considered to have several partitions of information including thesaurae, copies of previous manifests and declarations, external information sources reports, inspection reports, alerts and notices, and business rules.

In the business process flow, even though the diagram shows that the two kinds of documentation come into one system, it should be clearly understood what would occur in actual practice. Even though the Import/Export Declarations and the e-cargo manifests come in, essentially, together into the system there is an initial process to accomplish this flow. Initial screening happens when the e-cargo manifest (an advance copy) is transmitted electronically. An initial security profile is created by the Risk Management Module based on the information contained in this advance copy of the cargo manifest document. Based on this initial profile, the cargo/shipment is “tagged” according to risk levels. When the actual shipment arrives at the port, the Import/Export Declaration is submitted to the system. The next level of evaluation is to compare the Import/Export declaration with the e-cargo manifest previously submitted. If there is a discrepancy, the security profile is re-evaluated and would most probably be upgraded to high risk (based on defined business rules) because of this inconsistency in reporting. On the other hand, should there be no inconsistencies between the two documents, then the inspection method initially assigned to the shipment is carried out as indicated by the system, based on the initial and now confirmed security profile.

The risk management module, preferably a software-enabled engine, will extract the appropriate information from the documentation submitted and input in step 13 and step 14 of the business process. It develops a scaled risk profile where high risk is at one end of the scale and low risk is at the other. Gradations may be selected and points along the scale at which different responses will occur are preferably chosen by the user, based on the perceived security or other risk concern at the port or other trans shipment point at which this system will be used. For each shipment or container for which the electronic cargo manifests and import/export declarations are provided, a profile is developed in step 15. This profile will identify each shipment by a category of riskiness determined by information controlled by the system 21. The next step in the procedure is to sort the shipments by the profile in step 16, sending highest risk shipments either directly to physical inspection step 23 or scanning with gamma radiation step 17. Lower risk processes 18 and 19 provide for faster transshipment of the cargos which have lower risk profiles. If the cargos fail to pass through the inspection steps 17, 18, or 19, a physical inspection is required in step 23. If the physical inspection turns up contraband or other illegal, dangerous or otherwise impermissible cargos, the inspection is said to have failed, and failure procedures 25 are activated. These procedures may include confiscation of the cargo, notification of authorities and the like. Assuming that the selected procedure 17, 18, 19 or 23 discovers no unacceptable risks in the cargo, the cargo is allowed to pass 24.

The implementing seaports can program different combinations of inspection methods based on their individual requirements. Some port/custom authorities may opt to have all shipments scanned, regardless of security risks. The risk levels assigned by the system will then be used to determine the degree of inspection that will have to be applied. Other ports may opt for selective scanning and may provide fast lanes for low or no risk shipments. Still, other ports may opt for random scanning. In some instances a port may change its scanning activities pursuant to changes in perceived risk. In all instances, any suspicious result will require manual/physical inspection of the cargo.

Risk profiles are developed based on available information in the thesaurus and the knowledge base. Each of the data recorded in these repositories may be assigned numeric values that will indicate the nature of their relevance in relation to risk factors. For example, the data “Iraq” may be assigned a numeric value of 100 based on a scale of 1-100 because of the current security risk potential of that country. Another example may be the chemical substance plutonium, which is an active ingredient in the manufacture of nuclear bombs. On the other hand, non-risky data may be assigned lower numeric values. For example, the data “rice” may be assigned a value of 10. Using this method, each shipment is then profiled based on the relevant data or concepts contained in the submitted documents. Using the numeric values assigned to each data or concept, a profile of the shipment is then created by the system. For example, a shipment of mobile telephones coming in from China, passing through North Korea may be assigned the following profile:

| Data/ | Risk | |
|---|---|---|
| Concept | Value | Remarks |
| China | 50 | As a major trading partner, shipments from China |
| | | are generally considered medium-risk. |
| North Korea | 100 | Due to the existing trade embargo on North Korea, |
| | | and because of its nuclear program, any shipment |
| | | that originates or passes through this country is |
| | | considered high-risk. |
| Mobile | 80 | Mobile telephones are frequently used as |
| Telephones | | detonators for bombs. Also, shipments of these |
| | | devices are sometimes used as conduits for |
| | | smuggling smaller electronic equipment. However, |
| | | there are many legitimate importers who have |
| | | good records. Thus, a high-risk rating is assigned. |

Based on this profiling, the shipment may then be evaluated using the defined business rules. In the above example, 2 out of the 3 data or concepts derived from the submitted documentation are high-risk, while the remaining 1 is medium risk. This profile may be defined in the business rules as a high-risk shipment and therefore must pass through the container inspection system.

Another example is a shipment of microchips coming into the port of Los Angeles from Singapore shipped by a Company XYZ who has been exporting these chips to the US regularly for the last 10 years without any untoward incidence. The system may create the following profile for this shipment:

| Data/ | Risk | |
|---|---|---|
| Concept | Value | Remarks |
| XYZ | 0 | The company has had no derogatory record for the |
| Company | | last 10 years. |
| Microchips | 10 | There has been no reported incidence of this type |
| | | of shipment causing any security risk. |
| Singapore | 0 | This country implements a pre-shipment |
| | | inspection of all outgoing cargo. |

The created profile for the above example clearly shows a low-risk category for this shipment. Thus, the business rules may allow for this shipment to pass through a “fast lane”.

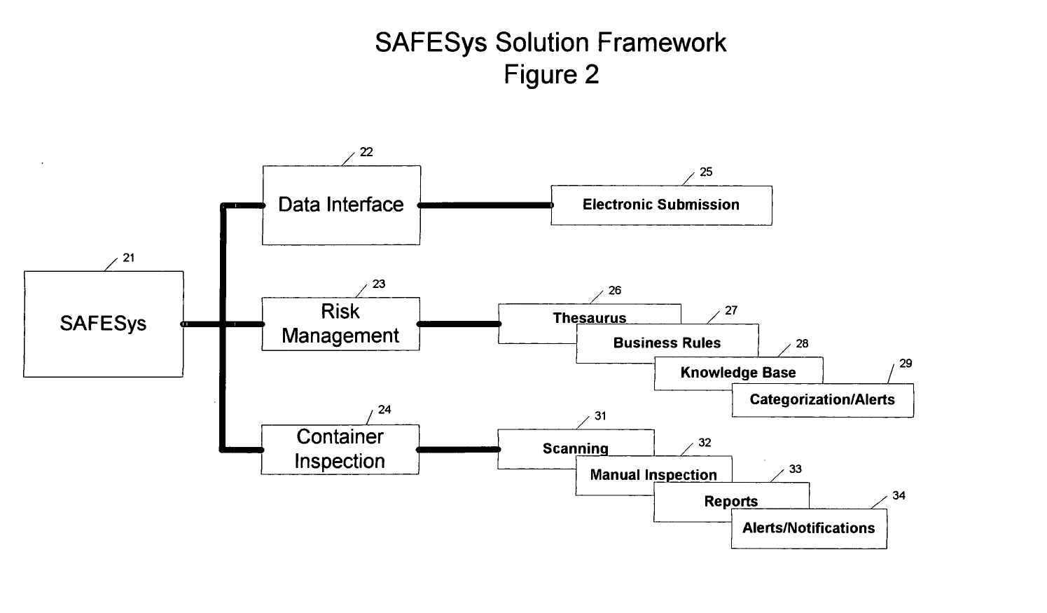

The solution framework is illustrated heuristically in FIG. 2 with what we call a SAFESys solution 21, having three main components. SAFESys is a name for the system we use in our preferred embodiment, but the reader will recognize that this is only our name for this system as it currently operates and that there may be some variation in this system without leaving the inventive bounds of this description. The components include an appropriate data interface 22 to allow for electronic submission 25 of all documentation to the security module. The security module will preferably be implemented in software on a general purpose computing platform or system. This data interface will also for communication between and among ports so that a worldwide SAFESys solution can be implemented. The risk management tools component 23 of the security module consists of a thesaurus module 26 which contains information regarding alternative names of cargos and associated information, business rules module 27 which describe situations in which cargos may or may not pass, a knowledge base module 28 which supports the other tools, and categorization and alerts component 29 which is a real time knowledge base supplementing the knowledge base module.

An important feature or component of the SAFESys solution framework 21 is the container inspection 24. This requires the ability to have gamma radiation scanning 31 of cargo containers which otherwise would need to be opened. A molecular analysis of the contents of the cargo container is available through such scanning as is well understood in the art. Manual inspection 32 is also required to supplement the gamma radiation scanning. Additional components including X radiation scanning, acoustic scanning, sniffer dogs and the like, may also be provided to supplement the system. Reporting component 33 and alerts and notifications component 34 are also necessary to communicate the information amongst various ports and to allow the system to respond dynamically and interactively with other such systems and businesses and governments that rely on the output of the SAFESys solution.

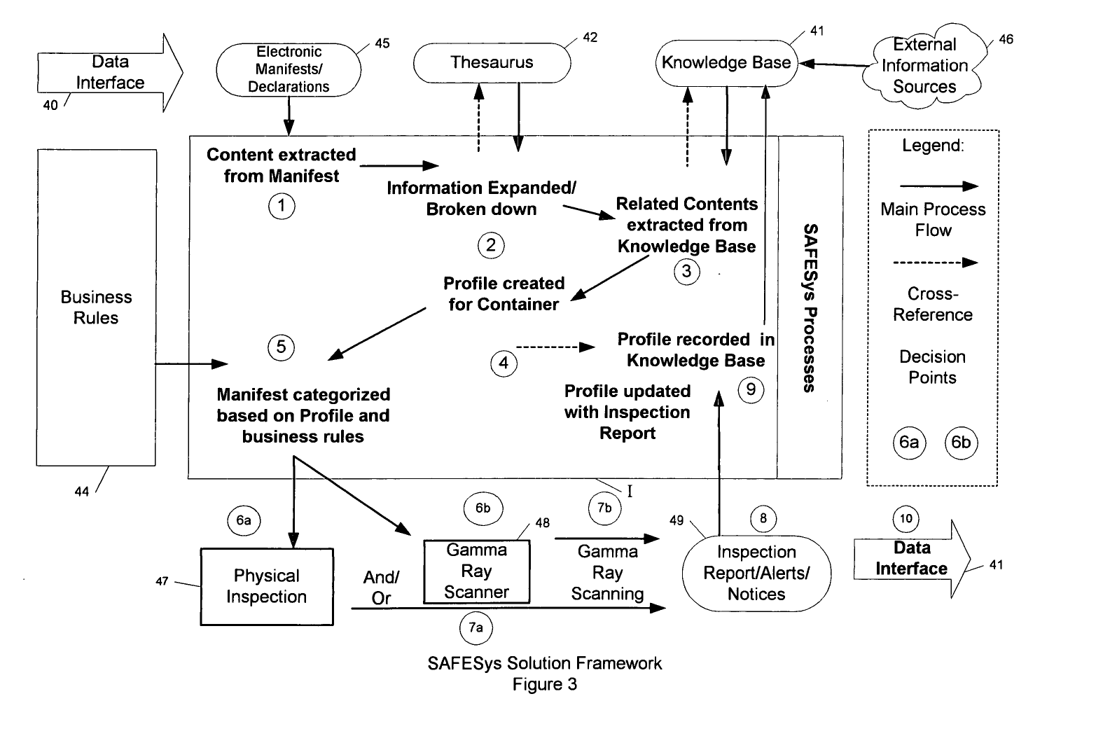

In FIG. 3 the solution framework 30 is broken down into conceptual components and processes. Everything starts with the data interface 40 through which the manifests and declarations are input 45. In certain cases the data may be entered manually and the manual entering may constitute the data interface, but this is not preferred. The content required to run the system is extracted from the manifests and declarations and there a decision point 1 may be reached. If the manifests or declarations are inadequate, the cargo may be pulled for inspection at that time.

The information is cross-referenced with information in the thesaurus 42 to determine what the data means and whether other rules need to be applied to it to determine whether or not it is safe and may or may not be transshipped through this point. If the information is of an unknown type or clearly falls into a category of dangerous materials, either a physical inspection or other process may be instituted at this decision point 2. The information generated to this point is passed through the knowledge base 43 which may be constructed from information from external sources, which may update or contradict information in the thesaurus if necessary. Additional analysis may be performed based on this information and a decision point 3 may determine whether the shipment should be stopped at this point. On the basis of the knowledge obtained about the shipment to this point, a profile is created for the container or cargo shipment being considered and at point 4 if the profile is too risky or cannot be created, manual intervention may be required. In any event, the profile is recorded in the knowledge base. Business rules 44 are applied against the profile and the information in the manifest for this particular shipment at point 5. Either physical inspection 47 and/or gamma ray scanning 48 is then undertaken unless the profile shows an extremely unrisky cargo and shipper as well as other earmarks of a safe cargo transaction. An inspection report 49 as well as any alerts and notices that are required are then developed based on the output from the previous process. Any changes in the profile that need to be updated based on this information are made to the knowledge base. A data interface 41 is again used to transport this information to businesses and/or governments requiring reports and information regarding the shipment.

The process starts when the cargo manifest is sent electronically. This provides advance information on the shipment's origin, destination, schedule, contents and other information. This is the stage when the initial evaluation is performed by the system. When the goods arrive, the captured details are compared with the import or export declaration and this consolidated information is the basis by which a secondary evaluation is performed by the system.

The information concerning the contents of the container is run through the Risk Management Module of our preferred embodiment which we call SAFESys for the initial screening. The Thesaurus can then compare the items in the manifest/declaration against its database for related information. For example, certain chemicals needed to manufacture methamphetamine hydrochloride (also known as Shabu or “poor man's cocaine”) may appear to be legitimate chemical imports needed to manufacture certain drugs.

However, when these items are checked against the Thesaurus, it will be identified as a component of an illegal drug when mixed with other chemicals. The Thesaurus can also identify what are the other substances needed to complete the illegal drug, and may even provide the probable sources of these substances. Thus, the system can provide the authorities with a more comprehensive profile of the shipment.

Based on this profile, an initial categorization of the shipment can be made. Business rules can be defined which when applied to the information developed form the Thesaurus above will categorize shipments according to the profile that has been created. For example, a profile can be categorized as follows:
Passed—when the profile does not produce suspicious results.
Conditional—when the profile produces some suspicious results but does not meet a set criteria level for a “Fail” category.
Fail—when the profile produces suspicious results.

Of course, any kind of scale of high risk to low risk could be used, but a simpler three-step scale such as the one above is our preferred design because of its simplicity. Thus, a container containing only one shipment by a shipper that has previously and regularly sent the same kinds of goods through this port in similar volumes would probably be considered, without more, a shipment that is not suspicious, and would be considered “Passed.” In a port where a Passed designation meant a quick trip through without more inspection, this would speed this container through that port. Where a port has a higher alert status, they may still subject the container to gamma radiation inspection processing, which if it turns up nothing suspicious would let the container through. Likewise, if the shipment is going through a suspicious port on its way here and is not properly locked, it would probably fail, under another one of the business rules suggesting that transshipment through the suspicious port required classification as a “Fail” or one suggesting that an improperly locked container be Failed.

In the previous example, the shipment under scrutiny may be that of for example, the chemical Chloride, a component in the manufacture of methamphetamine hydrochloride. On its own, the profile that will be created will identify this as a risky shipment since it contains a potentially illegal substance. The degree of risk that will be associated with the shipment will be determined with any other additional information provided, such as the company importing the chemical or the consignee. It would make a difference in the profile if the company importing the substance were a respectable pharmaceutical firm as opposed to a situation that the consignee is somebody who has been previously charged with possession of illegal drugs.

By creating categories and defining the criteria for each, human discretion in determining whether a shipment is suspicious or not is greatly minimize. This allows legitimate traders to move goods in and out of ports with greater ease and reduced waiting time while making it harder for contrabands and other illegal substances to pass through ports undetected.

Information that can be used for risk assessment may include historical data gathered in the course of using the system, including derogatory records of shipping companies, exporters, importers or forwarders. For example, an exporter who has a consistent record of inserting undeclared goods in their containers may have each and every container from their company inspected even if risk analysis of the goods being transported are not negative.

Trends in illegal shipment may also be taken into consideration. For example, components of explosive devices shipped within the vicinity of September 11 can be suspect, regardless of the good record of the company transporting them. This additional information enhances the information already available in the Thesaurus and the Knowledge Base and provides a more comprehensive source of information for profiling shipments.

By categorizing cargoes based on profiles, shipments can be initially tagged according to the levels of security that will be applied as they arrive on the port. While some shipments are categorized for inspection, some may be allowed to take the “fast lane” based on good profiling.

When the actual shipment arrives at the port, those that have been tagged for inspection goes through the Container Inspection module. Using Gamma Ray technology, this non-intrusive scanning device can produce not only an image of the contents of the container (as is the case in conventional X-Ray) but can also determine the molecular compositions of the contents. For example, substances that can be used for explosives maybe disguised as bars of soap inside the container. Using conventional X-ray equipment, the images may not show the difference between the real bars of soap and those that are made of the bomb substance.

The Gamma Ray device on the other hand is capable of determining the chemical composition of the content and provides this information to the system. The authorities will then have a more accurate basis for making decisions on whether to isolate and conduct physical inspection of the containers. The amount of time saved on avoiding physical inspections would reduce waiting time for the shipment and increase the capacity of the ports.

The economic implication to implementing agencies cannot be ignored. Without proper risk analysis and security tools, each and every shipment would have to be inspected in order to comply with US and international standards. Increased requirements for resources, both human and logistical, would put financial strains on the operation of these agencies.

SAFESys will provide a reliable alternative to indiscriminate inspection and assessment and will allow implementing agencies to selectively determine security levels. Scarce resources can then be used rationally and be focused on eliminating real risks and threats to security. The resulting efficiency and reduced processing time for legitimate cargo shipments would reflect on savings for end consumers as well.

SAFESys is built upon both new and existing technologies, driven by business requirements as necessitated by current and future needs. It takes into consideration the requirement for an effective and efficient system of securing trans-border supply chains to protect and enhance international trade against terrorist attacks. It is an information-driven solution that takes advantage of both existing and historical data generated by the system to rationalize the utilization of technology resources—thus reducing both acquisition and operational costs without sacrificing efficiency and reliability.

The two main modules of the solution, the Risk Management and the Container Inspection modules, complement each other to provide comprehensive and reliable profiling and scanning of shipments. These profiles enable authorities to make informed decisions in a fraction of the time using conventional methods. The system provides for internationally accepted standards as default business rules that can be used in the evaluation of information that comes from both the submitted manifests and declarations together with information generated as a result of previous physical inspections or Gamma Ray scanning. Additional business rules may be defined based on local laws and regulations.

A vital requirement to safeguard the information exchanged across the supply chain is data security and integrity. The system is maintained and operated on secured sites where only accredited and authorized users are allowed to access and transact. The SAFESys takes full advantage of web technology to provide a common, easy-to-understand user interface.

The combination of Gamma Ray technology and an extensive Risk Analysis and Management system reduces the probability of error on human judgment by providing objective and thorough assessment of both submitted and captured information through well-defined business rules. Properly implemented, the system not only increases confidence in the security of the supply chain in the country, but it will also encourage trade facilitation by providing fast, easy and reliable processing of shipment for legitimate traders.

Our preferred embodiment system should have the following major features:
It needs a Data Interface. This module provides the facility for the electronic submission of advance copies of manifest and import/export declarations for both incoming and outbound cargoes. The electronic documents may also be passed from existing computer systems already being implemented by port or customs authorities.
Some software must include Risk Management judgments. This module provides the capability to evaluate information provided in the manifests/declarations against stored information in the Knowledge Base, generating risk assessment based on pre-defined business rules. The following are sub-components of this module:
Preferably, the risk management function is organized into the following four components:
Thesaurus—provides a compilation of related information that can be associated with data captured from the manifests and declarations or from the Container Inspection module. This allows for “expanded” evaluation data by providing information that may normally be overlooked when manually reviewing the documentation. The Thesaurus takes the information, checks it against its database for alternative names, common mistakes in spellings, parts or components, composition, local and foreign counterpart terms and similar information. Based on the result of this cross-referencing, the information generated is used to extract from the Knowledge Base all pertinent information relating to the captured data.
Business Rules—these are standard sets of criteria that are internationally accepted. Local laws and regulations may be added to the standard rules for a more comprehensive coverage of assessment. These business rules determine how information provided on the manifest/declarations are interpreted and evaluated. The rules defined within the system provides the “business intelligence” required to properly assess information generated by the Thesaurus, and then use this to extract the information required from the Knowledge base. (See examples.)
Knowledge Base—this is the collection of information related to the profile of the shipment created through the use of the Thesaurus. The Knowledge Base contains information on where additional data may be obtained, and if the source is linked to the system, as for example by the Internet, users may choose to access such information when further analysis is required. Particularized reports such as Categorization/Alerts may be sent to the Knowledge Base by cooperating port (SAFESys-type) systems at other ports, automatically or with human intervention. Any properly classified information can act as a trigger to increase the security risk level assigned to a container.
Categorization/Alerts—based on the profiles and the business rules, the system is able to categorize the results according to pre-defined categories when properly classified and thus enabled to be incorporated into the Knowledge Base. Levels of security checking can be linked to these categories to identify which shipments need to undergo physical inspections.

The system must provide for Container Inspection. Shipments flagged for Gamma Ray inspection are normally those identified by the Risk Management module as potential risks. However, the degree of risk that will warrant such an inspection will again depend on how the business rules are defined. For some ports or during heightened alert times or the like, it may well be that all containers, regardless of risk potential will have to be scanned and physically inspected. At the other extreme, it could be that only highly suspicious cargo will be subjected to this inspection. Container inspection has, preferably, three main components:
Scanning—when a shipment is scanned, the results are fed back into the Risk Management module for comparison with the previously created profile of the shipment based on the advanced manifest and declaration. Deviations from what have been defined in the original profile and the result of the scanning are evaluated, again using defined business rules. Gamma Ray scanning produces both images and molecular data, enabling the system to have a better appreciation of the contents of the container without actual physical inspection. Even more important is that cleverly hidden contrabands that normally escape detection in conventional X-Ray imaging can be accurately detected through their molecular compositions. This is especially helpful in identifying substances or even smaller components that can potentially be used as weapons of mass destruction either on their own or as components thereof. This will also be a deterrent to bio-terrorism where substances that are normally harmless can be used as weapons of mass destruction when combined into fatal combinations. The complexity and sophistication by which these tools of terror are being developed requires a tool that is able to drill down to the lowest levels of identification in order to detect them, no matter how they are hidden or disguised in the containers.
Manual Inspection—should port officials require more proof to confirm results, physical inspection of the shipment may be requested. The result of this inspection will be fed back into the Risk Management module to add to the Knowledge Base. This will allow the system to “learn” so that the next time the same situation arises, the system will be able to deal with it using the information acquired during the process.
Alerts/Notifications—when results of the inspection are fed into the Risk Management module and the analysis of the profiles show significant discrepancy or deviations, or if the nature of the resulting profiles falls under categories that pose security threats, alerts and notifications can be generated by the system. Based on these alerts and notifications, lawful and appropriate actions can be taken by authorities against the shipment and those responsible for the shipment. These alerts and notifications are used also to update the profiles of the companies and cargoes involved.

The different components of an inventive system like our SAFESys system are maintained through data tables that interface with one another as information is passed, shared, consolidated and compared at different stages of the process.

As the illustration below shows, both the electronic copies of the manifest/declarations and the reports generated by the Container Inspection module are fed into the Risk Management module for risk assessment, using the Thesaurus and the Knowledge Base to create profiles for the shipments. The Business Rules defined in the Risk Management module, control how both the electronic manifest and the Container Inspection module reports are processed and evaluated.

The SAFESys system database can handle all types of data, including text, images and scientific data. It provides web access capability and allows concurrent access to a large number of users over both local area and wide area connections.

The above describes the data relationships within the system and how information is processed using business rules and the data definitions in the Knowledge Base, from the time the electronic manifest is received and lodged into the system, to when the actual import or export declaration is received electronically, until the container is either released or held pending further investigation.

To further illustrate how this works, we provide hypothetical examples: as in relation to business requirements, consider the following comparison between:

| | Cargo Container #1 | Cargo Container #2 |
|---|---|---|
| Steps | RTW from Hong Kong | Rice from Thailand |
| Step 1 | Ni Hao Mah Garments Factory | Sawasdee Rice Trading |
| Advance electronic | in Hong Kong ships 10,000 | Company in Thailand, a regular |
| copy of manifest is | pieces of denim pants to the | exporter of rice to the |
| received and | Philippines. It leaves Hong | Philippines, sends an electronic |
| lodged into the | Kong on 06 June, will stop | manifest for a shipment of 1,000 |
| system through the | over Sabah on 08 June before | metric tons of rice to arrive on |
| Data interface | proceeding to the port of | 10 September. The manifest also |
| module. | Manila on 09 June. An | indicated that it would be |
| | electronic copy of the manifest | shipped directly to the Port of |
| | was sent to Manila as soon as | Manila. |
| | all the garments were loaded | |
| | into the container on 01 June. | |
| Step 2 | Once the manifest is received, | SAFESys identifies 10 varieties |
| Shipment profile is | SAFESys extracts information | of rice exported by Thailand to |
| created by | from the manifest and checks it | the Philippines. One of these |
| extracting related | against the Thesaurus. The | varieties, the R18, is banned |
| information from | Thesaurus returns information | from entering the country in |
| the Thesaurus | on recent arms smuggling | certain quantities because it |
| based on | activities in Sabah, the | competes directly with local |
| information in the | stopover destination indicated | varieties. |
| manifest. | in the manifest. | |
| Step 3 | A check on the Knowledge | The most recent regulations on |
| The profile is used | Base produced news releases | the importation of R-18 rice is |
| to search for | on the Internet about increased | available in the Department of |
| information in the | terrorist activities in Sabah. | Agriculture website. Information |
| Knowledge Base. | The profile is updated using | from this site is provided by the |
| | this information. | Knowledge Base. The |
| | | Knowledge Base also returned |
| | | information on Sawasdee Rice |
| | | Trading Company, indicating |
| | | that its last 5 shipments of rice |
| | | went through inspection and |
| | | passed without any problem. |
| Step 4 | One of the business rules | The DA regulation states that |
| The initial profile | stipulates that any profile that | importation of 5,000 tons or less |
| is created and | may have any reference to | of R-18 rice is allowed. Also, 5 |
| categorized based | “terrorists” will be flagged for | consecutive inspections for |
| on the business | inspection. The shipment from | shipments of the same company |
| rules. | Ni Hao Mah Garments | for the same products make the |
| | although appearing to be a | company a “trusted trader”. The |
| | regular and legitimate shipment | shipment is categorized as a “no |
| | is tagged as a possible risk | or low risk” shipment. |
| | because of the stopover in | |
| | Sabah. | |
| Step 5 | When Ni Hao Mah's shipment | Upon arrival of the shipment, the |
| When the actual | arrives, the electronic copy of | electronic copy of the Import |
| shipment arrives, | the import declaration is | Declaration is submitted. |
| the Import | validated against the profile of | |
| declaration is | the manifest recorded in the | |
| electronically | system. | |
| submitted. | | |
| Step 6 | Ni Hao Mah's shipment did not | The information is validated |
| Any new | have any deviation from the | against the advance manifest. No |
| information, or | original manifest. The Import | deviations were noted. |
| changes in the | declaration shows that the | |
| original manifest | container contains 10,000 | |
| will be included in | pieces of Polo brand denim | |
| the shipment | pants. It also showed that it | |
| profile recorded in | stopped over in Sabah as | |
| the system. | planned. | |
| Profiles will be | | |
| categorized again | | |
| if there are changes | | |
| in the original data. | | |
| Step 7 | Since the shipment did stop in | The container is cleared for |
| Based on the | Sabah, the “potential risk” | release within the day of its |
| category of the | category of the shipment was | arrival. |
| shipment, cargoes | not changed. It cannot be | |
| can be cleared for | cleared for release | |
| release to | immediately. | |
| consignee, or . . . | | |
| Step 8 | The container is subjected to | No scanning is required. |
| Cargo container | Gamma Ray scanning. The | |
| will be subjected to | images on the screen showed | |
| Gamma Ray | no unusual forms on the | |
| scanning, or | container except the declared | |
| | denim pants. However, the | |
| | report on the molecular | |
| | composition of the contents of | |
| | the container indicates a high | |
| | concentration of cyanide, a | |
| | fatal poison. | |
| Step 9 | Because of this finding, a team | No physical inspection is |
| Cargo container | of bio-terrorism experts is | required. |
| will be opened and | called upon to physically | |
| physically | examine the contents of the | |
| inspected. | container. While securing a | |
| | court order, the container was | |
| | isolated to avoid possible | |
| | contamination. When finally | |
| | opened and sample of the pants | |
| | examined, it was discovered | |
| | that the fabric had been soaked | |
| | with a variant of cyanide that | |
| | can be absorbed by the skin on | |
| | contact. The poison can spread | |
| | through the nerve cells and | |
| | paralyze the brain and the heart | |
| | in less than 1 minute, leading | |
| | to sudden death. | |
| Step 10 | Based on these findings, the | No lawful actions required. |
| Based on the result | shipment was confiscated and | |
| of the inspections, | the entire crew of the ship | |
| cargo containers | detained for further | |
| may be subject to | investigation . . . | |
| lawful actions or | | |
| may be cleared for | | |
| release. | | |

In the first example cited above (Ni Hao Mah Garments), the implications of a security breach are quite clear. Had the shipment of the contaminated denims not been properly detected in time, ten thousand people or more could have died because of bio-terrorism. The data gathered by the system will be valuable in stopping similar incidents in the future, possibly stopping similar shipment even before it reaches the port of destination. The involved port will also be put under surveillance, and countries that may be adversely affected by future terror attacks that can be launched from this port may take multi-lateral actions jointly.

On the other hand, the rice shipment was correctly categorized based on information provided by the Knowledge Base, both factual (government regulations) and historical (good record of Sawasdee Rice Trading Company). The faster processing of the release of the shipment saved the importer huge amounts in storage fees, not to mention the savings realized from less incidence of spoilage due to the prolonged exposure of the rice to natural elements.

It should be noted that an operator has an option to increase the risk profile risk of any or all containers based upon external factors, such as high alert security bulletins on the news, reports from security agencies, or even personal hunches. Likewise the security level of an entire port facility can be changed by shifting the risk profiles of all cargo containers at once if desirable based again on any factors the operator feels appropriate to take into consideration.

It should be recognized that the Thesaurus and the business rules may be updated based upon the results of a search of a container that turns up a problem shipment. For example, if a shipment is determined to contain one component of a binary nerve agent, the country of origin, the shipper, the intended recipient, and similar information will be added to the factors from which risk level is determined for all subsequent systems.

Likewise it should also be clear that a system will be much more powerful if the Thesaurae of various ports are updated together. Thus, a communications path between the various port's SAFESys or similar systems should be established for this data sharing purpose.

These two example cases in the chart above illustrate only a few of the benefits that can be realized through the adoption of an integrated approach to container inspections and a risk management system.

The scope of this invention is only limited with reference to the following claims.

1. A method for handling cargo containers at transshipment points with a data management system, said method comprising;
ensuring data input in a format acceptable to a system for identifying contents and tracking at least one particular container,
identifying each container by a profile,
checking said data input for each profile against a thesaurus-like data recognizer software program having access to multiple terms for at least one of the data inputs, and expanding the total amount of information kept for containers by matches in said thesaurus-like data recognizer software, thereby expanding said profile,
checking other sources against said profile and determining whether data in said expanded profile has reference of interest to other sources' trigger information, and if so, adding said reference of interest to further expand said profile,
checking business rules against the expanded total amount of information for said particular container to determine a security risk level for said further expanded profile,
responding to said security risk level.

2. The method of claim 1 wherein said response to said security risk level is one of several responses including either
a) a manual search of said container,
b) gamma irradiation inspection processing of said container and re-evaluation of said container's risk based on results of said irradiation inspection processing,
c) minimal inspection of container, and
d) allowing passage through checkpoint.

3. The method of claim 2 wherein said responses are chosen based on a scaled risk profile having a high risk side and a low risk side and wherein said step a is reserved for containers having been evaluated with a risk profile toward the high end of the scale.

4. The method of claim 3 wherein regardless of a risk profile's scale, said container is subject to response b, and if as a result of said response b, a higher risk profile is developed for said container, then applying response a to said container.

5. The method of claim 3 wherein a low risk profile garners a c and d response from the system.

6. The method of claim 5 wherein if in a c response, a suspicious circumstance is found, exercising response b.

7. The method of claim 5 wherein if in a c response, a suspicious circumstance is found, exercising response a.

8. The method of claim 5 wherein if in a c response, a suspicious circumstance is found, exercising response a.

9. The method of claim 2 wherein under circumstances where an operator has an option to increase the risk profile risk of any or all containers based upon external factors.

10. A system for handling cargo containers at transshipment points that recommends particular handling processes based upon a risk profile comprising:
a security module having access to
a thesaurus module,
a business rules module, and
a Knowledge Base module having means for accepting external data input,
wherein said security module is for receiving documentary data input for each said container, and for processing said data through said thesaurus and said knowledge base module according to business rules in said business rules module, and through said processing according to said business rules for producing said recommendation.

11. The system of claim 10 wherein said recommendation corresponds to at least one of several handling processes.

12. The system of claim 11 wherein said handling processes comprises:
a) a manual search of said container,
b) gamma irradiation inspection processing of said container and re-evaluation of said container's risk based on results of said irradiation inspection processing,
c) minimal inspection of container, and
d) allowing passage through checkpoint.

13. The system of claim 12 wherein said security module has software for choosing responses based on a scaled risk profile having a high risk side and a low risk side and wherein said step a is reserved for containers having been evaluated with a risk profile toward the high end of the scale.

14. The system of claim 13 wherein regardless of a risk profile's scale, said security module software recommends that said container is subject to response b, and if as a result of said response b, a higher risk profile is developed for said container, then said security module software recommends applying response a to said container.

15. The system of claim 14 wherein if in a c response, a suspicious circumstance is found, said security module software recommends exercising response b.

16. The system of claim 5 wherein if in a c response, a suspicious circumstance is found, said security module software recommends exercising response a.

17. A port system for handling cargo containers at transshipment points that recommends and executes particular handling processes based upon a risk profile, and processes said cargo containers before releasing them through said transshipment point comprising:
inspection facilities having a manual inspection crew, a gamma irradiation
inspection processing facility, and a secure checkpoint, and
a security module having access to
a thesaurus module,
a business rules module, and
a knowledge base module having means for accepting external data input,
wherein said security module is for receiving documentary data input for each said container, and for processing said data through said thesaurus and said knowledge base module according to business rules in said business rules module, and through said processing according to said business rules for producing said recommendation.

18. The system of claim 12 wherein said recommendation corresponds to at least one of several handling processes.

19. The system of claim 13 wherein said handling processes comprises:
a) a manual search of said container,
b) gamma irradiation inspection processing of said container and re-evaluation of said container's risk based on results of said irradiation inspection processing,
c) minimal inspection of container, and
d) allowing passage through checkpoint.
